(19) United States
(12) Patent Application Publication
(10) Pub. No.: US 2009/0143100 A1
(43) Pub. Date: Jun. 4, 2009

(54) Portable office: cell phone & personal computer

(76) Inventor: Geoffrey P. Champion, South Plainfield, NJ (US)

Correspondence Address: Geoffrey P. Champion, 409 Randolph Avenue, South Plainfield, NJ, 07080, US

(21) Appl. No.: 11/998,628

(22) Filed: Dec. 1, 2007

(51) Int. Cl. H04M 1/00

(52) U.S. Cl. 455/556.2

(57) ABSTRACT

A fully functional cell phone that converts with ease into a fully functional personal computer with a fully functional keyboard layout in such a fashion, size of keys and spacing between to allow the users to use the standard technique of touch-typing. The transformation is simple, merely grab the tab on the numerical keypad pull and open the first 2 panels then the tabs on the side of the first alpha keyboard to relieve the other 2 panels. Open from left to right you have 4 panels connected by 3 hinges the 1^{st} panel is the left ½ an alpha keyboard, the second is a touch pad & display, the third the right ½ of an alpha keyboard and either the 1^{st} or last is a numeric keypad.

### BACKGROUND OF THE INVENTION

### Classification Definitions:

| | |
|---|---|
| Telephone cell | D14/138 |
| Lap top computer | D14/315 |

This invention relates to a portable electronic device that can adequately serve the function of a cellular telephone and a portable personal computer without compromising any of the functionality of either.

### BRIEF SUMMARY OF THE INVENTION

Presently no cell phone offers a fully functional cell phone and personal computer in one product. This invention's physical layout and easy conversion process provides an easy to use fully functional cell phone that transforms into a fully functional personal computer with ability to touch type using all your fingers not just your thumbs making it more practical to use as a personal computer. The invention relates to the need for a fully functioning cellular telephone and a fully functional personal computer without sacrificing any functions within the same unit.

The invention in its closed position has a numeric keypad, a display and other controls all in a comfortable layout as a cellular phone. With an optional digital camera placed on the back of the unit and all connections and ports are located to one side for easy access.

Then you easily unfold this unit simply by grabbing the tabs to reveal a split alpha keyboard hinged to a touchpad display in the middle and a numeric keypad to one side. All conveniently laid out with key sizes and format to use all 10 fingers to touch-type not just your thumbs. With the ability to touch type, having a number pad on one side, and the touch pad in the middle; this unit makes creating documents, reports, emails and any thing else which you can do on a computer very easy using standard personal computer software.

### BRIEF DESCRIPTION OF THE DRAWINGS

FIG. 1 Closed Front & Bottom Views—Cell phone keyboard & display

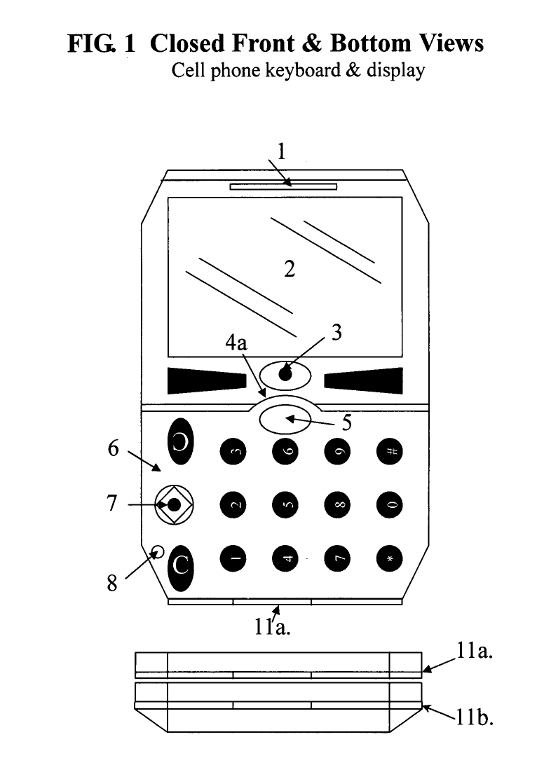

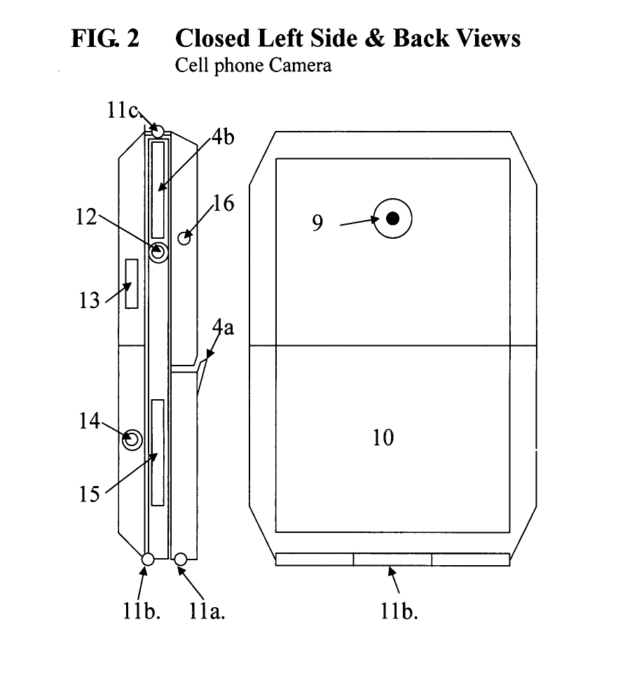

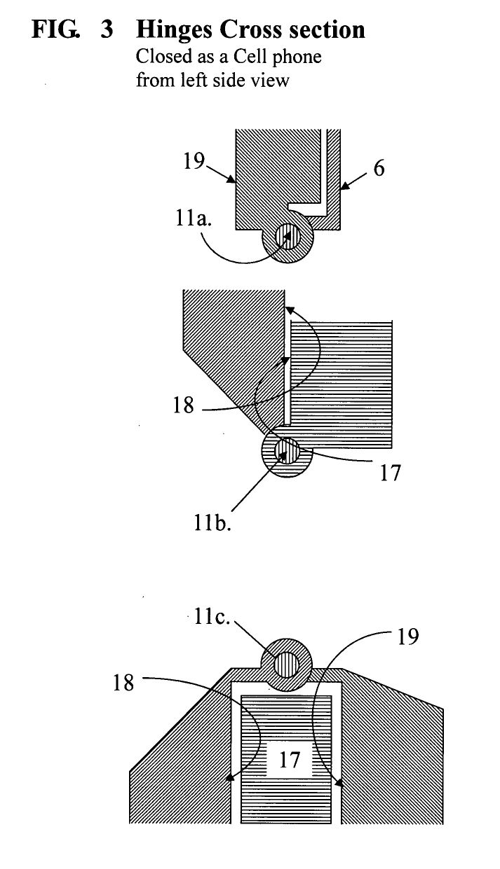

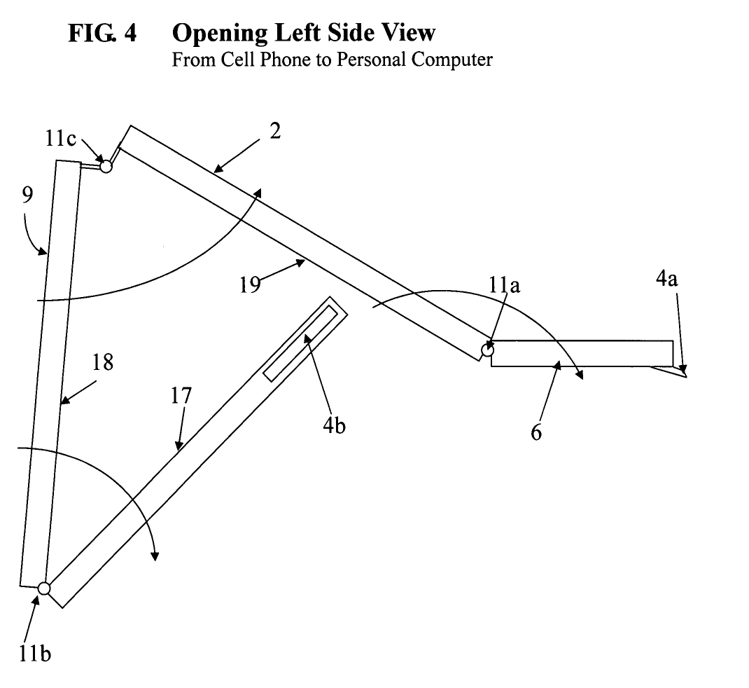

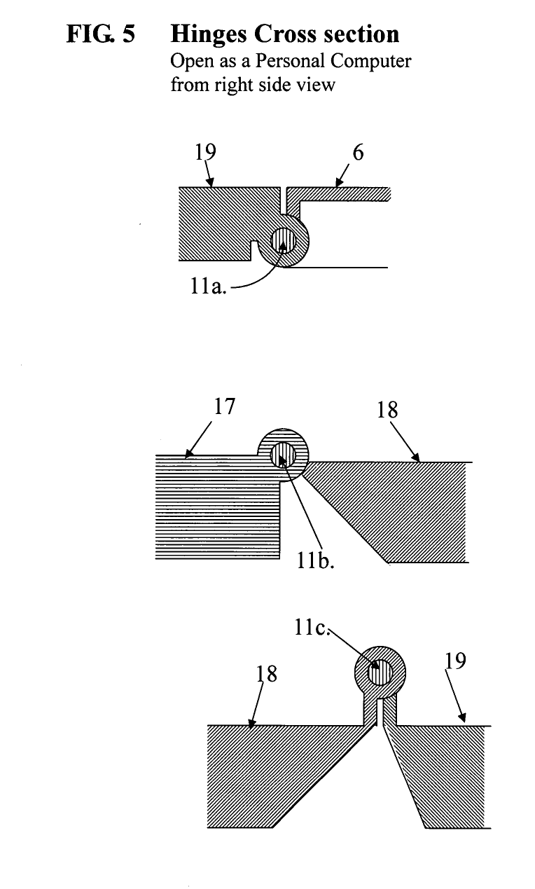

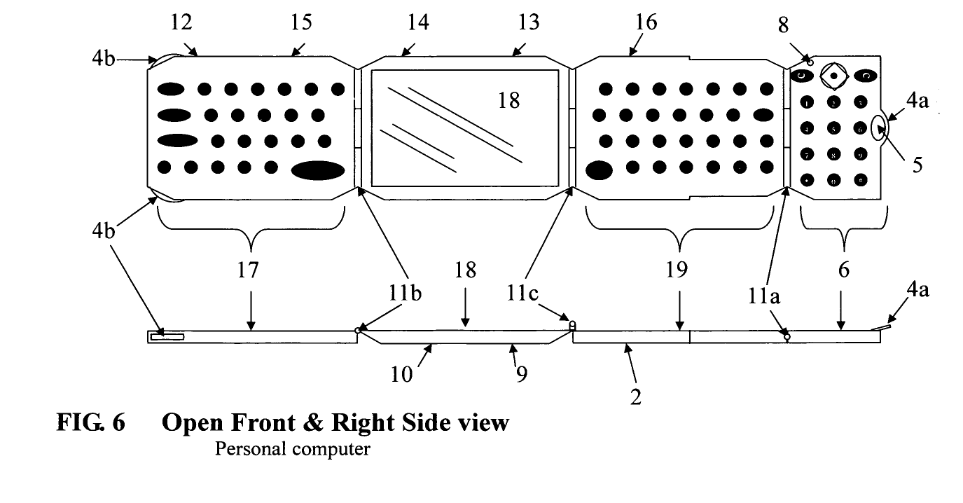

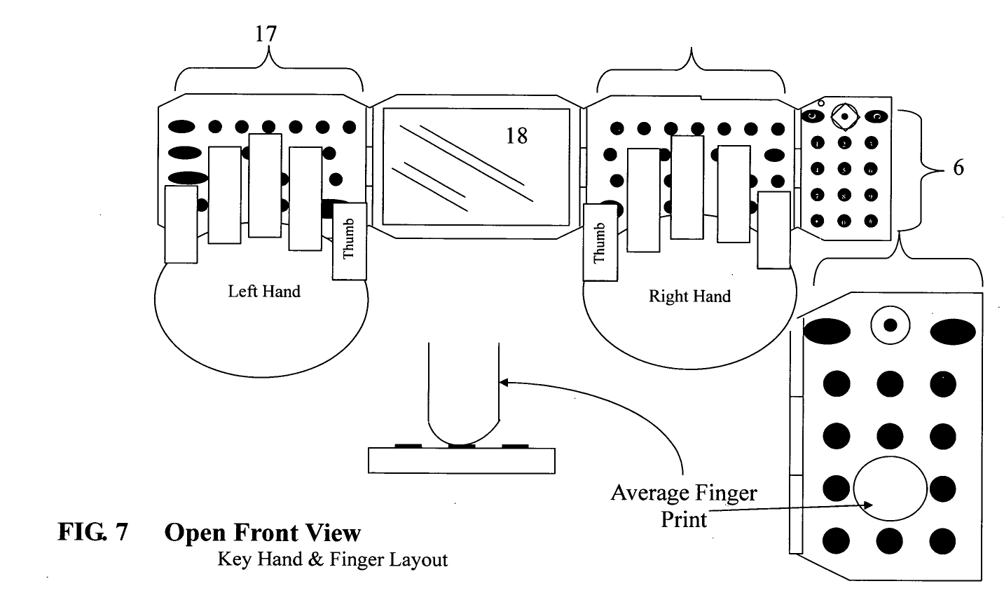

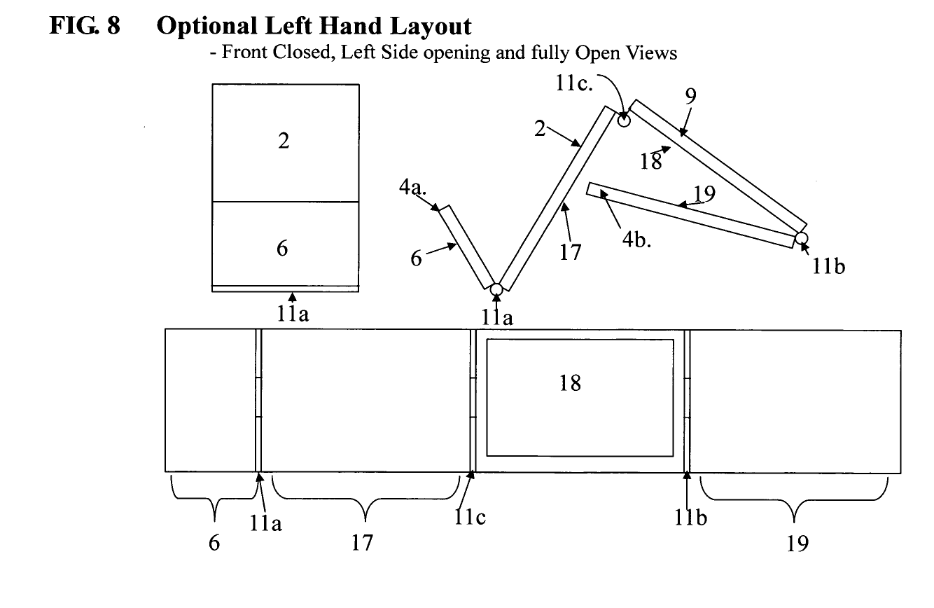

These drawing show the convenient layout of the invention in the closed position as a Cellular phone.

The Front View from top to bottom: 1 Ear piece, 2 Display, 3 (an optional) Camera Controls, 4a Primary tab to open numeric keypad and 1^{st} ½ of Alpha Keyboard, 5 Loud speaker 6 Numeric keypad with Call & End call Keys located on top, 7 Pointer controller, 8 Microphone, 11a Hinge to connect numeric keypad to right ½ of an Alpha keyboard.

The Bottom View from top to bottom: 11a. Hinge to connect numeric Keypad to right ½ of Alpha Keyboard, 11b Hinge to connect left ½ of Alpha Keyboard to Personal Computer Display and touch screen.

FIG. 2 Closed Left Side & Back Views—Cell phone camera

This drawing shows you possible locations for (optional) accessories to make this invention more versatile.

Left Side View from top to bottom: 11c hinge for Right ½ Alpha keyboard to the PC Display, 4b secondary tab to open the 2^{nd} Alpha keyboard, 16 Infrared port, 12 Ear & microphone plug, 13 USB port, 4a Primary tab to open numeric keypad and 1^{st} ½ of Alpha keyboard, 14 Power plug, 15 SD or any other Memory Card Slot, 11b hinge for left ½ of an alpha keyboard to the PC Display, 11a Hinge to connect numeric keypad to the Right ½ Alpha keyboard.

Back View from top to bottom: 9 A digital Camera Lens, 10 the cover for the battery, 11b Hinge connecting the Right ½ of the Alpha keyboard to the PC Display.

FIG. 3 Hinges Cross Section—Closed as a Cell phone

These drawing shows a sectional view looking from the left side of the 3 hinges used to unfold the invention in the closed or Cell phone orientation.

11a The hinge that connects 6 the numeric keypad to 19 the Right half of the alpha keyboard.

11b The hinge that connects 17 the Left half of the alpha keyboard to 18 the Touch & display screen for the P.C.

11c The hinge that connects 18 the Touch & display screen for the P.C. to 19 the Right half of the alpha keyboard allowing for space for 17 the Left half of the alpha keyboard to hide between.

FIG. 4 Opening Left Side View—From Cell Phone to Personal Computer

This Drawing shows how easy it is to transform the invention from a Cellular Phone to a Personal Computer.

From the left Side View you can see what happens when you grab and pull 4a the Primary Finger tab at leading edge of 6 the numeric keypad and pull which exposes 19 the right half of an Alpha Keyboard. Next, use the 4b. secondary tabs located on the both the left and right sides of 17 the Left ½ of the Alpha keyboard then just flip over keyboard which also will expose 18 the Personal Computer Display and touch screen.

FIG. 5 Hinges Cross section—Open as a Personal Computer

These drawing shows a sectional view looking from the right side of the 3 hinges used to unfold the invention in the Open or PC orientation.

11a The hinge that connects 6 the Numeric keypad to 19. the Right half of the alpha keyboard.

11b The hinge that connects 17 the Left half of the alpha keyboard to 18 the Touch & display screen for the PC

11c The hinge that connects 18 the Touch & display screen for the PC to 19 the Right half of the alpha keyboard allowing for space for 17 the Left half of the alpha keyboard to hide between.

FIG. 6 Open Front & Right Side view—Personal computer

The Front View of the Open Unit clearly illustrates the physical layout of the invention opened up to reveal a Personal Computer. From Left to right 4b the secondary Tabs to open 17 the Left ½ Alpha keyboard from, 11b hinge connecting the left ½ of Alpha keyboard to the PC Display & Touch screen 18 the Personal Computer display and touch screen, 11c hinge to connect the PC display & touch screen to the Right ½ of an Alpha keyboard, 19 the right ½ of the Alpha keyboard, 11a hinge to connect the right ½ of an Alpha keyboard to a numeric keypad 6. numeric keypad and in the panel are located 8. microphone, 5 loud speaker, 4a primary tab to open the numeric keypad. All the ports are located on the left side which becomes the back so as not to interfere with hand access from left to right 12 Ear and Microphone jack, 15 SD or any other Memory Card slot, 14 Power Plug, 13 USB Port. 16 Infrared.

The Right View of the Open unit clearly illustrates what the user will see when facing the unit From Left to right 4b the secondary Tabs to help you open 17 the left Alpha keyboard from 18, 11b hinge connecting the Left ½ of Alpha keyboard to the PC Display & Touch screen, 19 Computer Display and touch screen, 11c hinge to connect the PC display & touch screen to the Right ½ of an Alpha keyboard, 11a hinge to connect the right ½ of an Alpha keyboard to a numeric keypad 6 Numeric keypad, 4a primary tab to open the numerical keypad from the right Alpha keyboard and on the back side from left to right on panel 18, 10 Battery Cover, 9 Camera Lens, on panel 19, 2 Phone display just for reference purposes.

FIG. 7 Open Front View—Key Hand & Finger Layout

This drawing illustrates how this invention layout makes it easy to touch type. Left hand is comfortably located to cover 17 the left half of the alpha keyboard, 18 the display and touch screen located in the middle make it convenient to use, read and have a comfortable space between the hands, the right hand is comfortably located to cover 19 the right half of the alpha keyboard and 6 the numeric keypad is close and in an order to make it easy to locate keys.

The keys are separated and raised so as that an average person's finger will not mistakenly strike the wrong key, making it possible to touch type.

FIG. 8 Optional left Hand layout—Closed Front, Opening Side Left & Open Front Views

This drawing shows an optional layout for the invention for those who prefer the numeric keypad located on the left side it is 11a hinged to the left half of the alpha keyboard thus the unit unfolds in reverse.

### DETAILED DESCRIPTION OF THE INVENTION

Closed the “Portable Office” provides all the functions of a cell phone; open it acts as a fully functional personal computer.

Closed the front has 6 a numeric keypad formatted to easily dial phone numbers and send text messages. 8 A microphone to speak into and 1 a earpiece to hear the person on the other end of a phone call. 7 A pointer to access phone commands on 2 a Display to display phone commands, phone numbers, contacts, appointments, text messages, review e-mail, and preview pictures from the camera. Under the display is located 3 the (optional) Camera controls to take a picture using 9 the (optional) Camera lens on the Back side of the Invention. Located on the left side are all the ports 12 a jack to connect earphones and a microphone, 16 infrared to transfer data, 13 a USB port to exchange information with a Printer, Personal Computer, Network or any other accrues, 14 a power plug to charge the internal battery, 15 an SD Storage or other Card Slot to add memory and exchange information i.e. Pictures, Contacts, Appointments, Documents, Presentations, and any other programs. This unit would use standard cell phone software and have the capabilities to communicate with blue tooth wireless accessories and use standard voice commands.

Opening you easily unfold the 4 panels connected by 3 hinges this transforms a basic cell phone into a personal computer that is easier to control. Simply grab and pull 4a. the tab located at the leading edge of 6 the numeric keypad which also reveals 19. the right ½ of the alpha keyboard then 4b. use the tabs located on the side of 17 the left hand ½ of an alpha keyboard and flip over the other ½ exposing the 18 Computer Display and touch pad.

Open the front has 4 panels from left to right; 17 the 1^{st} is one half of an Alpha keyboard in a QWERTY, international or any other format the client wants format designed for the left hand to use, the next 18. a display and touch pad to view and help access what you are doing on your computer and or telephone, then 19 the 3^{rd} panel designed for the other half of an Alpha keyboard designed for the right hand, finally the last panel has a numeric key board. 6 The numeric keypad can be located after the right panel or before the left in the left hand option, depending on the desires of person who favor their left hand. All the ports are located on the left side which becomes the back when open so as not to interfere with the person typing when it is being used as a personal computer. This unit would use standard operating systems and programs and have the capability of using standard wireless networks.

Also in both position Open or Closed it would be GPS enabled and the blue tooth functions and commands would work so that open it could still be used as a phone and Navigational device. Along with standard recording and playback capabilities it could be used for music or video again in either mood.

1. What I claim as my invention is that in the Closed Position: A comfortably easy to use fully functional hand held cellular phone with a Display, controls and a easy to use numeric keypad.

2. What I claim as my invention is that when Opening: The invention easily open using 3 hinges that open 4 panels from a hand held cellular phone and turns into a fully functional personal computer.

3. What I claim as my invention is that in the Open Position: A Personal computer controlled by a divided Alpha keyboard with a touchpad display located in the middle and a numeric keypad on one side.

4. What I claim as my invention is that the numeric keyboard may be located to either the right or optional left hand side of the unit when open

5. What I claim as my invention ref. to claim 1, 3 & 4 the keys are of the size, spacing, and arrangement to allow for touch typing ie: QWERTY, internal or others for the alpha keys and a numeric pad layout the same as a calculator and a phone.

6. What I claim is that the ports are located all on one side not interfering with the person using the invention in either the cell phone or personal computer form.

7. What I claim is that an optional digital camera may be included or not depending on the clients desires.
